(19) United States
(12) Patent Application Publication
(10) Pub. No.: US 2005/0048188 A1
(43) Pub. Date: Mar. 3, 2005

(54) Method for processing fish of red flesh

(75) Inventor: Kazumi Okuda, Numadu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Harumi Suisan Limited Company, Numadu-shi (JP)

(21) Appl. No.: 10/897,654

(22) Filed: Jul. 23, 2004

(30) Foreign Application Priority Data
Jul. 25, 2003 (JP) 2003-279549
Mar. 5, 2004 (JP) 2004-61501

(51) Int. Cl. A23B 4/00

(52) U.S. Cl. 426/643

(57) ABSTRACT

A method for processing a fish of red flesh includes a packing step of cutting a fish in such a shape as would fit immediate use by consumers, piling the cut fish orderly on a tray and stowing the cut fish on the tray into a pack, a vacuumizing step of filling the pack during the packing step with a vacuum atmosphere, a gas-filling step of filling the pack immediately after completion of the vacuumizing step with a mixed gas of carbonic acid gas and oxygen gas without exposing the interior of the pack to the ambient air, thereby exposing the fish to the mixed gas, a pack-sealing step of tightly closing the pack filled with the carabonic acid and the oxygen gas, and a freezing step of quickly freezing the fish contained in the pack and transforming the fish into a frozen fish.

### BACKGROUND OF THE INVENTION

1. Field of the Invention

This invention relates to a method for processing a fish, particularly a fish of red flesh, such as tuna or bonito, by cutting the fish into such pieces as would suit Immediate use by consumers and then treating the cut pieces so that they may be preserved for a long time while retaining the freshness thereof for a long time, preventing the color thereof from being stained by chromogenic variation and suffering no impairment of the palatability like raw flesh of fish and, when thawed, shunning discoloration and loss of palatability.

2. Description of the Prior Art

Generally in the deep-sea fishery, the caught fish is quickly frozen at a temperature of −60° C. or less in the fishing boat, the frozen fish is landed on the pier of the base port and carried into the market and put to bidding, and the frozen fish handed to the dealer winning the bid is thawed and prepared by this dealer for further handling. In the coastal fishery, the caught fish is stored as on the deck of the fishing boat, landed on the pier of the home port, carried into the market and put to bidding and prepared by the dealer winning the bid for further handling.

The large fish of red flesh, such as tuna or bonito, cannot be stored for a long time unless it is frozen because the tissue and cells of the fish tend to decompose and denature and the chromogen thereof yields to serious variation and denaturation. When the frozen fish is directly thawed, the thawed flesh is at a disadvantage in incurring serious degradation of quality, yielding to discoloration into a brackish tint, oozing a discolored fluid, and consequently degrading outward appearance and palatability and seriously impairing commercial value.

As measures for overcoming these disadvantages, a method which causes the fish brought to a refrigerating temperature to be exposed to an oxygen gas and a carbon dioxide gas for a long time till the fish absorbs the two gases thoroughly, then freezes the fish to below a freezing temperature and put the frozen fish to storage and a method which comprises cutting the fish into pieces of a prescribed size and quickly freezing the cut pieces by means of liquefied nitrogen or liquefied carbonic acid have been known hitherto from WP-A HEI 7-123912 and JP-A 2001-169719.

Even such conventional methods as mentioned above are at a disadvantage in not only entailing works liable to consume great time and labor but also suffering the fish, when left standing in a refrigerator at 0 to −3° C. for 16 hours, to generate countless coliform bacteria far exceeding the standard tolerance specified by the Food Sanitation Law and render itself no longer rit for distribution as frozen food and, when the refrigerator is made to discharge the entrapped air for the sake of sealing in the gases and then vacuumized again, exposing the fish twice to the vacuumized state and compelling the cells and the tissue of the fish to be seriously denatured to the extent of inducing emission of drips, seriously impairing the palatability of the fish and staining the color of the fish

These methods further require use of a special refrigerating device. The fish of red flesh is disposed to have the tissue and the cells thereof denatured and stained to a blackish tint when the temperature and the duration of processing are delicately changed. Thus, the fish processed by these methods cannot be commercially accepted as the materials for foodstuffs, such as sashimi (slices of raw fish) and sushi (a dish of cold rice garnished with bits of raw fish or seafood) that are particularly consumed raw.

An object of this invention is to provide a method for processing a fish of red flesh by cutting the fish in such a shape as would be directly used by consumers and treating the cut fish, thereby enabling it to be stored for a long time without suffering the freshness, color and palatability thereof to vary with the elapse of time.

Another object of this invention is to provide a method for processing a fish of red flesh by freezing the fish in such a manner that when the frozen fish is thawed, the thawed fish does not assume a blackish tint because the thawing neither decomposes, varies or denatures the tissue and the cells thereof nor varies the chromogen thereof but affords nearly the same appearance and palatability as fish in its raw state.

Still another object of this invention is to provide a method for processing a fish of red flesh by treating the fish in such a manner that when the frozen fish is thawed and then retained for a long time (approximately 3 to 5 days) in a refrigerator having an average temperature of 10° C. or less, the refrigerated fish does not suffer the tissue, cells and color thereof to vary or denature but retains the quality of elasticity and the inherent color and consequently enjoys a markedly high commercial value.

### SUMMARY OF THE INVENTION

A method for processing a fish of red flesh according to one aspect of this invention comprises a packing step of stowing in a pack a fish cut in such a shape as would fit immediate use by consumers, a vacuumizing step of conferring an interior of the pack containing the fish with a vacuum atmosphere, a gas-filling step of filling the pack immediately after completion of the vacuumizing step with a mixed gas of carbonic acid gas and oxygen gas and exposing the fish thereto, a pack-sealing step of sealing the pack containing the gas and the fish, and a cold working step of setting the pack which has undergone the pack-sealing step in a state of cold temperature, allowing the fish to age, and enabling the gas to permeate the fish and activate it.

A method for processing a fish of red flesh according to another aspect of this invention comprises a packing step of stowing in a pack a fish cut in such a shape as would fit immediate use by consumers, a vacuumizing step of conferring an interior of the pack containing the fish with a vacuum atmosphere, a gas-filling step of filling the pack immediately after completion of the vacuumizing step with a mixed gas of carbonic acid gas and oxygen gas and exposing the fish thereto, a pack-sealing step of sealing the pack containing the gas and the fish, a cold working step of setting the pack which has undergone the pack-sealing step in a state of cold temperature, allowing the fish to age and enabling the gas to permeate the fish and activate it, and a freezing step of quickly freezing the fish contained in the pack, thereby transforming it into a frozen fish.

A method for processing a fish of red flesh according to still another aspect of this invention comprises a first freezing step of quickly freezing a fish caught as in deep-sea fishery in its original round state, a cutting step of cutting with a mechanical means the fish frozen by the first freezing step, a thawing step of causing the fish cut by the cutting step to assume a half-thawed state capable of being cut with an edged tool, a packing step of cutting the fish thawed by the thawing step with an edged tool into such a shape as would fit immediate use by consumers and stowing the cut fish in a pack, a vacuumizing step of conferring an interior of the pack containing the fish with a vacuum atmosphere, a gas-filling step of filling the pack immediately after completion of the vacuumizing step with a mixed gas of carbonic acid gas and oxygen gas and exposing the fish thereto, a pack-sealing step of sealing the pack containing the gas and the fish, a cold working step of setting the pack which has undergone the pack-sealing step in a state of cold temperature, allowing the fish to age, and enabling the gas to permeate the fish and activate it, and a second freezing step of quickly freezing the fish contained in the pack, thereby transforming it into a frozen fish

According to this invention, the mixed gas used in the gas-filling step results from mixing 20 to 50 vol. % of carbonic acid gas and 50 to 80 vol. % of oxygen gas, the cold working step is carried out at a temperature in the range of 1 to 15° C. for a period in the range of 30 minutes to three hours, and optionally the packing step is allowed to place a tray and/or a sheet inside the pack and enable it to absorb the blood and the dripping fluid and retain the shape of the fish.

The method of this invention for processing the fish of red flesh prevents is the tissue and the cells of the fish from being varied and denatured via activation by enveloping the fish with a vacuum atmosphere, thereby sterilizing the fish and preventing it from being oxidized on contact with the ambient air as welt exposing the fish immediately after the vacuumizing step to the mixed gas of carbonic acid gas and oxygen gas, and retaining the fish in a cold state for a prescribed period, thereby allowing it to age. When the fish is cooked and readied for ingestion, it is not stained in a blackish tint but is allowed to retain entirely the same palatability as the fish in a raw state. When this meat is preserved in an ordinary household refrigerator for several days it does not suffer the quality thereof to vary or the color thereof to stain. It, therefore, brings an effect of being ingested in its unaltered state by consumers.

### DESCRIPTION OF THE PREFERRED EMBODIMENT

This invention is directed toward infallibly solving the task of preventing the tissue and cells of a fish from being deteriorated via denaturation and variation by a procedure which comprises retaining in a pack the fish in a vacuum state for a brief period to sterilize it and keeping it from exposure to the ambient air to prevent it from being oxidized, filling the pack immediately after the vacuumizing step with a mixed gas of carbonic gas and oxygen gas to expose the fish to the mixed gas, and retaining the temperature incapable of freezing the fish for a prescribed period, thereby allowing the fish to age. Further, since the fish immediately after the vacuumizing step is kept from contacting the ambient air and kept in contact with the mixed gas, the fish frozen thereafter, preserved in the frozen state for a long time and thereafter thawed, can be infallibly prevented from being oxidized. Since the fish has not gathered aerial infectants to its surface, it can be prevented from sustaining denaturation of the tissue or variation of the chromogen.

Now, the embodiments of this invention will be described below.

The first embodiment of this invention comprises a packing step of cutting a fish of red flesh, such as tuna or bonito, caught in the deep-sea fishery and not undergone quick freezing by mechanical means or manually with an edged tool such as a kitchen knife, in a proper size into sashimi, slices or slabs which would fit immediate use by consumers, piling the cut pieces orderly on a tray and stowing the fish together with the tray into a resin pack impervious to the air.

In the packing step mentioned above, when the fish ready to be piled on a tray is placed in a tray which has laid a sheet made of non-woven fabric, cloth or thick paper on the bottom surface thereof, the fish can be prevented from being deteriorated by the adhesion thereto of the fish fluid, such as the blood and the juice, emitted when the meat is cut, because the sheet is capable of absorbing the fish fluid. The tray is intended also to retain the shape of the fish piled on the tray.

When the appearance of the fish does not count as a commercial article, the tray and the sheet are no essential requirements for the packing step. It is permissible to use either the tray or the sheet. When the fish is used as a sashimi for ordinary household consumption, since it is required to keep a good appearance, it is commendable to place the fish on the tray cushioned with the sheet so as to enable the sheet to absorb the blood, juice and drips and the tray to retain the shape of the fish.

As the pack for use in the packing step, it is commendable to adopt a resinous bag that manifests weatherability, resistance to cold, resistance to liquid and imperviousness to air.

The pack that has contained the cut fish has one end thereof left open. By undergoing the vacuumizing step, it is allowed to enclose a vacuum atmosphere, keep the fish from contacting the ambient air and consequently manifest an effect of sterilizing the fish and preventing it from being oxidized as well, and preclude denaturation and variation of the flesh and chromogen of the fish. The duration of the vacuumizing step is extremely short. Specifically, several seconds to some tens of seconds suffice. When the fish is exposed to the vacuum state for an unduly long time, the tissue and cells of the fish are denatured and the palatability thereof is degraded, and the color thereof is stained to a blackish tint.

When the fish is exposed to a vacuum condition and isolated from the ambient air even for a brief time, it is made to manifest a function of preventing oxidation because the cells and tissue thereof are sterilized and the flesh thereof is retained in the raw state and they are further kept from the oxygen in the ambient air. When the fish is exposed to the vacuum state for a long time, the flesh thereof is deteriorated. Thus, the duration of the exposure is only required to be enough for effecting the sterilization and inducing the function to prevent oxidation.

When the interior of the pack is vacuumized by the vacuumizing step, the subsequent gas-filling step that fills the pack with the mixed gas of carbonic acid gas and oxygen gas and exposes the fish to the mixed gas is carried out. This gas-filling step is carried out immediately after completion of the vacuumizing step in such a manner as to keep the fish from contacting the ambient air.

As regards the ratios of the mixed gas to the carbonic acid gas and to the oxygen gas in the gas-filling step, the ratio of the carbonic acid gas is in the range of 20 to 50 vol. % and that of the oxygen gas in the range of 50 to 80 vol. %. The mixing ratio of these two gases is a necessary condition for retaining the tissue and cells of a fish of red flesh, such as tuna or bonito, in its original state safe from denaturation or variation.

Immediately after completion of the gas-filling step, a mechanical pack-sealing step that comprises tightly closing the opening part of the pack and preventing the mixed gas from being released from the pack is carried out.

The vacuumizing step, gas-filling step and pack-sealing step are automatically implemented by a continuous process inside a vacuum packing apparatus which operates to mount the pack containing the fish on a conveyor in motion, vacuumize the pack and fill it with the gas while the pack is in the process of conveyance and tightly close the opening part of the pack.

The three steps mentioned above can be fulfilled in about one minute.

After the vacuumizing step, gas-filling step and pack-sealing step are executed by one vacuum packing apparatus, the pack is discharged from the apparatus and it is transferred to the cold working step.

The cold working step is intended to retain the fish at such a temperature as is incapable of freezing it for a prescribed time. The chilled chamber of a refrigerator may be utilized for this step.

The cold working step retains the fish at a temperature in the range of 1 to 15° C., preferably 5 to 10° C., for a period in the range of 30 minutes to three hours, preferably one to two hours. If the temperature is lowered below 1° C. at the cold working step, it will possibly freeze the fish. If the temperature exceeds 15° C., it will possibly induce the fish to generate a function of self-digestion and soften itself. If the period falls short of 30 minutes, the shortage will prevent the fish from being aged satisfactorily. If it exceeds three hours, the excess will possibly warm the fish to the extent of manifesting a function of self-digestion.

By the cold working step, the fish is aged and the components of the carbonic acid gas and oxygen gas thoroughly permeate the interiors of the tissue and cells of the fish and activate them and prevent the tissue, cells and chromogen of the fish from being denatured or varied.

When the fish is retained in the resultant state for a long time, the freshness and tint of the fish are not varied. When the frozen fish is thawed, the tissue and cells thereof are not decomposed, varied or denatured. Since the chromogen is not varied, the fish is not stained into a blackish tint. Thus, the fish is enabled to manifest substantial the same appearance and palatability. Even in the state frozen and subsequently thawed or even after preservation in a refrigerator at an average temperature of 10° C. or less for a long time (about three to five days), the meat does not suffer the tissue, cells and color thereof to vary or denature but retains the quality of elasticity and the inherent color and consequently enjoys a markedly high commercial value.

When the processed packed fish is displayed on a neighborhood shop and used by a consumer within about three to five days after the cold working step, it may be frozen or distributed at normal room temperature. When the process of distribution requires one week or more, however, it is commendable to have the fish in the sealed pack subjected to the freezing step of quick freezing.

The second embodiment of this invention is aimed at subjecting the pack resulting from the cold working step to the freezing step resorting to quick freezing with a view to prolonging the freshness of the fish. The packing step, vacuumizing step, gas-filling step, pack-sealing stop and cold working step involved herein are identical with those involved in the first embodiment mentioned above.

The freezing step is a step known as an ordinary way of preservation by freezing. It consists in continuously freezing the pack at a temperature in the range of −30 to −70° C., preferably −40 to −60° C., for a period of two hours or more. It enables the fish to be preserved for a very long time and nevertheless permits the freshness and the chromogen thereof to remain intact.

When the fish preserved so frozen as described above is thawed at normal room temperature or inside a refrigerator at a temperature of 10° C. or less, it retains the raw state without suffering the quality of fish to vary or the chromogen of the red flesh of the fish to stain in a blackish tint or discolor. Further, since the tissue and cells of the fish are neither denatured nor varied and the quality of the fish is not deteriorated, the fish manifests the same palatability as the fish in the raw state. Thus, the fish loses no commercial value and brings no change in terms of food sanitation. As a result, it can be utilized in the raw state for cooking as sashimi and other dishes to be used in families, sushi shops and restaurants and as toppings for sushi, for example,

When the frozen fish is thawed and directly stored in a refrigerator, the fish even after the elapse of at least three days still remains the state of raw fish because the quality and the chromogen of the fish remain intact.

The third embodiment of this invention comprises a first freezing step of quickly freezing a fish of red flesh, such as tuna or bonito, caught in the deep-sea fishery in its round state at a temperature in the range of −40 to −60° C. in the fishing boat and putting the frozen fish to storage, a cutting step of forcibly cutting the quickly frozen fish landed on the pier of the base port of the fishing boat by a mechanical means into blocks or slabs, a thawing step of soaking the cut fish in brine (sea water or equivalent water containing about 5% of a salt component) and half-thawing it to a temperature in the approximate range of −4 to +4° C., a packing step of cutting the frozen fish mechanically as in the first embodiment or manually with an edged tool in such a shape as slabs, slices or sashimi as would fit immediate use by consumers, optionally heaping the cut fish orderly on a tray and placing the fish together with the tray in a pack optionally cushioned with a sheet, a vacuumizing step of forming a vacuum atmosphere in the pack formed at the packing step and precluding oxidation of the fish by removing the air from the fish or sterilizing it, a gas-filling step of filling the pack immediately after the vacuumizing step with a mixed gas of carbonic acid gas and oxygen gas and exposing the fish to the mixed gas, a pack-sealing step of tightly closing the pack after completion of the gas-filling step so as to preclude the escape of the mixed gas, a cold working step of setting the pack which has undergone the pack-sealing step in a state of cold temperature, allowing the fish to age and enabling the gas to permeate the fish and activate it, and a second freezing step of continuously keeping the pack containing the cold-worked fish at a temperature in the range of −30 to −70° C., preferably in the range of −40 to −60° C. for a period of two hours or more.

The first freezing step is aimed at quickly freezing the fish caught in the deep-sea fishery in the round state, i.e. in an uncut form, with a device in the fishing boat because the fishing boat engaging in the deep-sea fishery continues a voyage for several months at a time and is compelled to preserve within the fishing boat the fish caught during the voyage.

When the fishing boat returns to the home port and lands the frozen fish on the pier, a market employee, a dealer winning the bid or other dealer performs the cutting step of forcibly cutting the round frozen fish with a mechanical means into blocks or slabs.

The frozen fish that has been cut by the cutting step is then subjected to the subsequent thawing step of soaking the frozen fish in brine and half-thawing it till a hardness enough to be manually cut with an edged tool, such as a kitchen knife. This thawing step consists in soaking the fish in sea water or salt water containing about 5% of a salt component till the fish reaches a temperature im the approximate range of −4 to +4° C. In the resultant state, the fish can be cut mechanically or manually with a kitchen knife.

The fish half-thawed by the thawing step is cut in such a proper size as would suit immediate use for cooking by a consumer such as, for example, sashimi, slices and slabs. The cut fish is piled orderly on a tray optionally cushioned with a sheet intended for the removal of blood, fluid and drips. The fish is then subjected to the packing step of stowing the fish together with the tray into a pack.

Then, the pack containing the fish is supplied to a vacuum-packing device and subjected therein to the vacuumizing step, which fills the pack with a vacuum atmosphere and consequently keeps the fish from contacting the ambient air to sterilize it and prevent it from being oxidized. Particularly when the fish is kept from contacting the ambient air, it has the cells and tissue thereof sterilized and acquires an ability to preclude oxidation.

The pack containing the fish which has been sterilized and prevented from oxidation by the vacuumizing step is subjected, immediately after that step and while continuously kept from contacting the ambient air, to the gas-filling step which fills the pack with the mixed gas of carbonic acid gas and oxygen gas.

After the gas-filling step is completed, the pack-sealing step which is aimed at tightly closing the pack so as to preclude escape of the mixed gas from the pack and subsequently setting the pack at a state of low temperature, thereby aging the fish and causing the mixed gas in the pack to permeate the fish and activate it. Optionally, the second freezing step that is aimed at quickly freezing the fish contained in the pack and transforming it into a frozen fish is carried out.

The vacuumizing step, gas-filling step, pack-sealing step, cold working step and the quick freezing step involved in the second embodiment are identical with those involved in the first embodiment and, therefore, will not require a specific explanation.

As respects the first and second embodiments, while the first embodiment is directed toward processing for preservation within the fishing boat the fish caught in the coastal fishery in the raw state, i.e. in a form not quickly frozen, the second embodiment is aimed at processing for preservation within the fishing boat the fish caught in the deep-sea fishery and quickly frozen in the round form. The two embodiments are nearly identical in respect of the other steps.

Now, the test results will be explained.

Table 1 shows the results of a test performed to detect the composition of Tuna A in the certificate issued on Jun. 13, 2003 by an official organ and Table 2 the results of a test performed to detect the composition of Tuna B in the certificate issued on Jun. 13, 2003 by the same official organ.

The test on Tuna A was requested by Harumi Suisan Limited Company and performed by Japan Inspection Association of Food and Food Industry Environment (JIAFE) at Shimizu Office of 1-39 Hinode-cho, Shimizu, Shizuoka-ken 424-0922, Japan. The sample offered on May 27, 2003 to this Association was tested. The results of this test are shown in Table 1 below.

TABLE 1

| Items | | Limit of | | Foot- |
|---|---|---|---|---|
| of test | Results | detection | Method of test | note |
| Energy | 106 kcal/100 g | — | — | *1 |
| Water | 73.1 g/100 g | 0.1 g/100 g | Method of drying | |
| | | | at constant level | |
| | | | of 105° C. | |
| Protein | 24.6 g/100 g | 0.1 g/100 g | Kjeldahl method | *2 |
| Lipid | 0.8 g/100 g | 0.1 g/100 g | Ether extraction | |
| Carbohydrate | 0.1 g/100 g | 0.1 g/100 g | — | *3 |
| Ash | 1.4 g/100 g | 0.1 g/100 g | Incineration | |

*1: The coefficients, protein 4, lipid 9 and carbohydrate 4, were used.
*2: The coefficient, 6.25, was used.
*3: Carbohydrate = 100 − (water + protein + carbohydrate + ash).

The test on Tuna B was requested by Harumi Suisan Limited Company and performed by JIAFE at Shimizu Office of 1-39 Hinode-cho, Shimizu, Shizuoka-ken, 424-0922, Japan. The sample offered on May 27, 2003 to this Association was tested. The results of this test are shown in Table 2 below.

TABLE 2

| Items | | Limit of | | Foot- |
|---|---|---|---|---|
| of test | Results | detection | Method of test | note |
| Energy | 106 kcal/100 g | — | — | *1 |
| Water | 73.2 g/100 g | 0.1 g/100 g | Method of drying | |
| | | | at constant level | |
| | | | of 105° C. | |
| Protein | 24.6 g/100 g | 0.1 g/100 g | Kjeldahl method | *2 |
| Lipid | 0.8 g/100 g | 0.1 g/100 g | Ether extraction | |
| Carbohydrate | 0.1 g/100 g | 0.1 g/100 g | — | *3 |
| Ash | 1.3 g/100 g | 0.1 g/100 g | Incineration | |

*1: The coefficients, protein 4, lipid 9 and carbohydrate 4, were used.
*2: The coefficient, 6.25, was used.
*3: Carbohydrate = 100 − (water + protein + lipid + ash).

Tuna A was the sample obtained by causing a round tuna caught in the deep-sea fishery and quickly frozen within the fishing boat to be mechanically cut when it was landed on the pier of the home port of the fishing boat, allowing the cut fish to be half-thawed by spontaneous standing till −2° C. and cutting the half-thawed fish with a kitchen knife into the shape of sashimi, heaping 100 g of the sashimi orderly on a resinous tray having a foam polystyrene sheet laid on the bottom surface thereof, stowing the sashimi on the tray in a pack of soft resin, supplying the pack containing the sashimi to a gas-processing device, subjecting the packed sashimi therein to a vacuumizing treatment with a degree of vacuum of 3 torrs for a period of 40 seconds, then immediately filling the pack with a mixed gas of 70 vol. % of oxygen gas and 30 vol. % of carbonic acid gas, is tightly closing the pack and quickly freezing the sashimi in the pack at −60° C., allowing the frozen packed sashimi to stand for one month, delivering the resultant packed sashimi to JIAFE, and having the sashimi thawed in a refrigerator of JIAFE and given a gas treatment properly.

Tuna B was the sample of the same fish as Tuna A, obtained by causing a round tuna caught in the deep-sea fishery and quickly frozen with the fishing boat to be mechanically cut when it was landed on the pier of the home port of the fishing boat, having 100 g of the cut fish in its unmodified form frozen for one month, delivering the resultant cut fish together with Tuna A to JIAFE, and having the cut fish thawed in a refrigerator of JIAFE and given no gas treatment.

When these two samples were tested to determine the six items, i.e. energy, water content, protein content, lipid content, carbohydrate content and ash content, the results covered by the certificates of test results of Tables 1 and 2 indicate that the sample given no gas treatment had a water content larger by 0.1 g, in the whole amount of 100 g of sample, than the sample given the gas treatment, that the sample given the gas treatment had an ash content larger by 0.1 g, in the whole amount of 100 g of sample, than the sample given no gas treatment and that absolutely no change was detected in all the other items.

These results prove that the tuna which was given the gas treatment by the method of this invention possessed perfectly the same tissue as the tuna which was given no gas treatment and that it manifested substantially no change in color.

When Tuna A and Tuna B were left standing for one day in an ordinary household refrigerator having the interior temperature kept at an average of 8° C. and then examined visually, Tuna A manifested virtually no change and Tuna B was found to have the flesh thereof softened and the chromogen thereof stained wholly in a blackish tint. When they were left standing for two days in the refrigerator having the interior thereof kept at an average temperature of 8° C., Tuna A manifested virtually no change and Tuna B had to be discarded because it had the flesh thereof markedly softened till a putrefied state and had the chromogen thereof stained wholly in a blackish tint. When Tuna A was removed from the refrigerator after standing therein for three days, it manifested no change in palatability and taste and retained the same color as during the thawing.

Table 3 shows the detection of coliform bacteria in a frozen tuna in the certificate issued on Jul. 14, 2003 by JIAFE.

The test on the frozen tuna was requested by Harumi Suisan Limited Company and performed by JIAFE at Shimizu Office of 1-39 Hinode-cho, Shimizu, Shizuoka-ken, 424-0922, Japan. The sample offered on Jul. 9, 2003 to this Association was tested. The results of this test are shown in Table 3 below.

TABLE 3

| | | Limit | | |
|---|---|---|---|---|
| Items of test | Results | of detection | Method of test | Footnote |
| Bacteria count | 6500/g | — | *1 | |
| Coliform bacteria | Negative | — | *1 | |

*1: Standard tolerance of food and additives, Item 1 Food, D Frozen food.

The tuna of this sample, though different from a frozen fish, was obtained similarly to Tuna A mentioned above by causing a round tuna caught in the deep-sea fishery and quickly frozen within the fishing boat to be mechanically cut when it was landed on the pier of the home port of the fishing boat, allowing the cut fish to be half-thawed by spontaneous standing till 0° C. and cutting the half-thawed fish with a kitchen knife into the shape of sashimi, heaping 100 g of the sashimi orderly on a resinous tray having a foam polystyrene sheet laid on the bottom surface thereof, stowing the sashimi on the tray in a pack of soft resin, supplying the pack containing the sashimi to a gas-processing device, subjecting the packed sashimi therein to a vacuumizing treatment with a degree of vacuum of 4 torrs for a period of 30 seconds, then immediately filling the pack with a nixed gas of 70 vol. % of oxygen gas and 30 vol. % of carbonic acid gas, tightly closing the pack and quickly freezing the sashimi in the pack at −60° C., allowing the frozen packed sashimi to stand for one month, and thereafter delivering the resultant packed sashimi to JIAFE.

The section titled “Frozen Food” in the “Standard Specifications of Food, Additives, etc.” according to the Food Sanitation Law specifies “an un-preheated and frozen food (of the frozen food, that which is obtained by freezing a food manufactured or processed in advance and which is supposed to require no heating prior to ingestion, which is definition similarly applies in the present section) is required to have a bacteria count of not more than 100,000 per 1 g of a sample and manifest negative coliform bacteria. The method for determining the bacteria count (number of live microbes) and the method for testing for the coliform bacteria are as shown below and describes these methods.

When the samples mentioned above which were delivered to JIAFE, an official organ, were tested in strict accordance with such testing methods, the bacteria count was found to be 6500/g and the coliform bacteria to be negative. These results indicate that the samples were highly superior as frozen food and passed the test.

According to this invention, therefore, the fish of red flesh caught in the coastal fishery or the fish of red flesh caught in the deep-sea fishery can be processed so as to withstand protracted preservation in entirely the same state as the fish in the raw state without impairing the flesh of the fish at all or staining the chromogen of the fish. The processed fish can be conveyed to consumers in the family, restaurants and sushi shops. Even after the processed fish is thawed, the flesh of the fish and the chromogen thereof can be retained intact for a very long time.

1. A method for processing a fish of red flesh, comprising:
a packing step of stowing in a pack a fish cut in such a shape as would fit immediate use by consumers;
a vacuumizing step of conferring an interior of the pack containing the fish with a vacuum atmosphere;
a gas-filling step of filling the pack immediately after completion of the vacuumizing step with a mixed gas of carbonic acid gas and oxygen gas and exposing the fish thereto;
a pack-sealing step of sealing the pack containing the gas and the fish immediately after the gas-filling step; and
a cold working step of setting the pack which has undergone the pack-sealing step in a state of cold temperature, allowing the fish to age and enabling the gas to permeate the fish and activate it.

2. A method for processing a fish of red flesh, comprising:
a packing step of stowing in a pack a fish cut in such a shape as would fit immediate use by consumers;
a vacuumizing step of conferring an interior of the pack containing the fish with a vacuum atmosphere;
a gas-filling step of filling the pack immediately after completion of the vacuumizing step with a mixed gas of carbonic acid gas and oxygen gas and exposing the fish thereto;
a pack-sealing step of sealing the pack containing the gas and the fish immediately after said gas-filling step;
a cold working step of setting the pack which has undergone the pack-sealing step in a state of cold temperature, allowing the fish to age and enabling the gas to permeate the fish and activate it; and
a freezing step of quickly freezing the fish contained in the pack, thereby transforming it into a frozen fish.

3. A method for processing a fish of red flesh, comprising:
a first freezing step of quickly freezing a fish caught as in deep-sea fishery im its original round state;
a cutting step of cutting with a mechanical means the fish frozen by the first freezing step;
a thawing step of causing the fish cut by the cutting step to assume a half-thawed state capable of being cut with an edged tool;
a packing step of cutting the fish thawed by the thawing step with an edged tool into such a shape as would fit immediate use by consumers and stowing the cut fish in a pack;
a vacuumizing step of conferring an interior of the pack containing the fish with a vacuum atmosphere;
a gas-filling step of filling the pack immediately after completion of the vacuumizing step with a mixed gas of carbonic acid gas and oxygen gas and exposing the fish thereto;
a pack-sealing step of sealing the pack containing the gas and the fish;
a cold working step of setting the pack which has undergone the pack-sealing step in a state of cold temperature, allowing the fish to age and enabling the gas to permeate the fish and activate it; and
a second freezing step of quickly freezing the fish contained in the pack, thereby transforming it into a frozen fish.

4. The method according to claim 1, wherein the mixed gas at the gas-filling step has 20 to 50 vol. % of carbonic acid gas and 50 to 80 vol. % of oxygen gas mixed therein.

5. The method according to claim 2, wherein the mixed gas at the gas-filling step has 20 to 50 vol. % of carbonic acid gas and 50 to 80 vol. % of oxygen gas mixed therein.

6. The method according to claim 3, wherein the mixed gas at the gas-filling step has 20 to 50 vol. % of carbonic acid gas and 50 to 80 vol. % of oxygen gas mixed therein.

7. The method according to claim 1, wherein said cold working step is implemented at a temperature in the range of 1 to 15° C. for a period in the range of 30 minutes to three hours.

8. The method according to claim 2, wherein said cold working step is implemented at a temperature in the range of 1 to 15° C. for a period in the range of 30 minutes to three hours.

9. The method according to claim 3, wherein said cold working step is implemented at a temperature in the range of 1 to 15° C. for a period in the range of 30 minutes to three hours.

10. The method according to claim 1, wherein the packing step has a tray and/or a sheet inserted in the pack.

11. The method according to claim 2, wherein the packing step has a tray and/or a sheet inserted in the pack.

12. The method according to claim 3, wherein the packing step has a tray and/or a sheet inserted in the pack.
